(19) United States
(12) Patent Application Publication
(10) Pub. No.: US 2020/0214295 A1
(43) Pub. Date: Jul. 9, 2020

(54) SEED TREATMENT AND RELATED METHODS AND APPARATUS

(71) Applicant: Hodder & Taylors Limited, Feilding (NZ)

(72) Inventors: Duncan THOMAS, Feilding (NZ); Paul OLIVER, Feilding (NZ)

(21) Appl. No.: 16/615,736

(22) PCT Filed: May 22, 2018
(86) PCT No.: PCT/NZ2018/050069

§ 371 Date: Nov. 21, 2019

(30) Foreign Application Priority Data
May 22, 2017 (NZ) 732122
Nov. 14, 2017 (NZ) 737325

(51) Int. Cl. A01N 43/80; A01N 35/02; A01N 25/00; A01C 1/06

(52) U.S. Cl. CPC A01N 43/80; A01C 1/06; A01N 25/008; A01N 35/02

(57) ABSTRACT

The current disclosure includes various seed treatments. Some of these treatments comprise metaldehyde, saponin, and an agriculturally acceptable film coating composition. Some of the treatments include saponin. Some of the treatments include metaldehyde in powder form. This disclosure also includes methods of coating seeds with such seed treatments, and also apparatus for doing do. In some examples, the seed treatments are configured to repel molluscs.

### FIELD OF THE DISCLOSURE

The present disclosure relates to seed treatments and related methods and apparatus, and more specifically to compositions and methods for treating seeds having mollusc-repellent properties. The disclosure further relates to a method and apparatus for manufacturing such seed treatments.

### BACKGROUND OF THE DISCLOSURE

Controlling pests on horticultural crops often involves the use of pesticides and fungicides. Broad-acre application of these materials (that is, the general application of materials to crop-sites), however, can have environmental costs and can cause health concerns for people and animals in close proximity to the materials.

Metaldehyde (2,4,6,8-tetramethyl-1,3,5,7-tetroxocane) is used in pesticides targeting slugs, snails and other gastropods. The compound is included in pellets which additionally comprise a bait. In order to be effective against slugs, metaldehyde baits are generally applied to crop fields at a rate of, at least, 4 kilograms per hectare, more typically 4 to 8 kg per hectare (see, for example, the product label for the metaldehyde pellet “Endure™”, Ravensdown, New Zealand). Metaldehyde is toxic to mammals, including dogs and humans. Surface application of metaldehyde pellets therefore risks ingestion by pets and children. A bittering agent is often included in an attempt to reduce this risk.

Saponin is a type of amphipathic compound having one or more hydrophilic glycoside moieties combined with a lipophilic sapogenin (commonly a triterpene or triterpenoid derivative). As used herein, the term “saponin” refers to any saponin product and covers mixtures of specific saponins, and/or concentrated saponin, and/or powdered saponin compounds and/or compositions of which saponin is an active ingredient.

### SUMMARY OF THE DISCLOSURE

It is an object of the present disclosure to provide a seed treatment composition having, and/or method and/or apparatus for treating seeds to have, a mollusc-repellent property, and/or which addresses, overcomes or ameliorates at least one of the disadvantages of known metaldehyde agricultural products or other molluscicidal agricultural products, and/or which at least provides the public with a useful choice.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”

The present disclosure relates to the finding that a seed treated with a combination of metaldehyde and saponin effectively repels molluscs, in particular gastropods, from damaging seeds and germinated seedlings.

The present disclosure further relates to a method of applying metaldehyde to a seed in a sufficient amount to have a mollusc repellent effect on the seed and germinated seedling.

The present disclosure further relates to mollusc-repellent properties of saponin, and relates to seed treatments comprising saponin and methods of applying saponin to a seed so as to achieve a treated seed and germinated seedling having mollusc repellent effect.

Treated seeds and their germinated seedlings according to the present disclosure have been found to have a mollusc repellent effect such that good establishment of crops is obtained even in the presence of molluscs. In other words, the effect is such that there is no requirement to kill the molluscs—the seed treatment is such that the seedlings and subsequent larger plants establish well, even with live molluscs remaining in the area.

The present disclosure also relates to a method and apparatus of treating or coating seeds.

Herein, the definition of the terms “seed treatment”, “treated seed” and the like are intended to be synonymous with, and encompass, amongst other things, the definitions of artificial seed coatings, seed protectants, seed encrustation, seed enhancements, seed dressings and other artificial additions to the seed.

In one aspect, there is provided a seed treatment, preferably for repelling molluscs, comprising:
metaldehyde;
saponin; and
an agriculturally acceptable film coating composition.

In a further aspect, there is provided a method of applying a coating to a plant seed including the steps of:
applying saponin to the seed
applying metaldehyde to the seed
applying an agriculturally acceptable film coating composition to the seed.

A preferred saponin product is the saponin product obtained from Sapindus mukorossi. The saponin product may be obtained in a concentrated liquid formulation comprising 80% by weight saponin content. However, saponin may also be obtained from other sources such as the soap bark tree for example, Quillaja saponaria.

The preferred concentration of saponin used is a liquid composition of 80% saponin content, but more dilute concentrations may be used, for example, 20% saponin. More concentrated compositions may be used. Powdered saponin may be used.

Preferably, saponin is in a liquid formulation and is relatively concentrated. For example, the liquid saponin formulation is preferably greater than 20% saponin content, more preferably 20 to 100% saponin content, and most preferably about 80% saponin content. Preferred ranges of saponin in the seed coating applied to seed is 0.1 to 10 ml per kg of seed, more preferably 1 to 8 ml per kg of seed, most preferably 2 to 5 ml per kg of seed. Expressed as a percentage, the concentration of saponin in the treatment may in some examples be between 7 to 30%, in some examples between 10 to 20%, and in some examples is approximately 12.5%.

Preferably, metaldehyde is a solid powder, for example 99% TC grade metaldehyde powder. Preferred ratios of metaldehyde in the seed coating is at least 3 g/kg of seed, more preferably greater than 3 g/kg of seed, 5 to 50 g/kg of seed, most preferably between 10 and 30 g/kg seed.

In a further aspect, there is provided a treated plant seed, preferably for repelling molluscs, comprising a seed coating comprising metaldehyde, saponin and an agriculturally acceptable film coating composition.

Preferably, the plant and plant seeds for treatment are selected from: brassica, pasture, pasture herb, cereal, corn, rice, sorghum or pulse crops.

Preferably, the mollusc being repelled is a gastropod, more preferably a slug or snail. When the treated seed is rice, it is particularly preferable that the treatment is configured to controldamage from the golden apple snail.

In a further aspect, there is provided a method of controlling mollusc damage to plants and plant seeds, comprising treating the plant seed with a combination of metaldehyde, saponin and an agriculturally acceptable film coating composition. Preferably, the mollusc is a gastropod, more preferably a slug or snail. When the treated seed is rice, it is particularly preferable that the treatment controls damage from the golden apple snail.

In a further aspect, there is provided a method of applying a coating to a plant seed including the steps of:
wetting the seed;
applying metaldehyde powder to the seed;
applying an agriculturally acceptable film coating composition to the seed.

A seed coated according to any of the above methods is also provided.

Preferably, metaldehyde is a solid powder, for example 99% TC grade metaldehyde powder. Preferred ranges of metaldehyde in the seed coating is at least 3 g/kg of seed, more preferably greater than 3 g/kg of seed, 5 to 50 g/kg of seed, most preferably between 10 and 30 g/kg seed

Preferably, the plant is selected from brassica, pasture, pasture herb, cereal, corn, rice, sorghum or pulse crops.

Preferably, the ratio of the volume or mass of the seed being coated in a given batch to the volume or load rating of a mixing drum in which the seed is coated, is controlled or varied.

In a further aspect, there is provided an apparatus for coating a plant seed as herein described. The apparatus preferably comprises: a rotatable drum in fluid communication with a first source of a liquid composition and a second source of an agriculturally acceptable film coating composition, the drum being configured to receive and mix the seed, the liquid composition and the coating composition, further including a powder feeder configured to feed metaldehyde powder to the drum. The first and second sources may each comprise a tank or chamber or reservoir configured to contain the liquid and coating compositions. The tank or chamber or reservoir may be located on or at the apparatus, or remote from the apparatus and in fluid communication with the apparatus via suitable connections. The connections may comprise one or more pipes, conduits or conveyors.

In a further aspect, there is provided a seed treatment formulation or composition, preferably for repelling molluscs, comprising:
metaldehyde; and
an agriculturally acceptable film coating composition.

In a further aspect, there is provided a treated plant seed comprising a seed coating comprising metaldehyde in powder form and an agriculturally acceptable film coating composition.

In a further aspect, there is provided a method of applying a coating to a plant seed including the steps of:
applying metaldehyde in powder form to the seed
applying an agriculturally acceptable film coating composition to the seed.

In a further aspect, there is provided an apparatus for coating a plant seed comprising a rotatable drum in fluid communication with a first source of an agriculturally acceptable film coating composition, a powder feeder configured to feed metaldehyde powder to the drum, the drum being configured to receive and mix the seed, the metaldehyde powder and the coating composition to coat the seed.

In a further aspect, there is provided a method of applying a coating to a plant seed including the steps of combining metaldehyde and saponin and an agriculturally acceptable film coating composition in a formulation, preferably in combination with suspending agents to improve dispersion of metaldehyde, and applying the formulation to seed. An alternative method of applying a coating to a plant seed includes the steps of combining metaldehyde and saponin in a formulation, preferably in combination with suspending agents to improve dispersion of metaldehyde, and applying the formulation to seed, followed by the subsequent application of an agriculturally acceptable film coating composition to the seed.

In a further aspect, there is provided a seed treatment formulation, preferably for repelling molluscs, comprising:
saponin; and
an agriculturally acceptable film coating composition.

There is also provided a method of applying a seed treatment formulation to seed, the method comprising combining a saponin with an agriculturally acceptable film coating composition to form a liquid mixture and applying the mixture to seed in a rotary drum. An alternative method comprises applying a saponin formulation to seed followed by the subsequent application of agriculturally acceptable film coating.

In a further aspect, there is provided a treated plant seed, comprising a treatment applied to the surface of the seed which comprises saponin and an agriculturally acceptable film coating.

In an example, the saponin is in a liquid composition at about 80% concentration, and the agriculturally acceptable film coating composition may be a water-based polymer coating composition.

### BRIEF DESCRIPTION OF THE DRAWINGS

The disclosure will now be described by example only and with reference to the Figures, in which:

FIG. 1a is a photograph of a 0.25 m² mat in a paddock sown with seeds of the present disclosure, as described under the Trial heading, below.

FIG. 1b is a photograph of the overturned mat of FIG. 1a.

FIG. 2 is a schematic of an apparatus configured for manufacture of a seed treatment in accordance with the current disclosure.

### DETAILED DESCRIPTION

A seed treatment formulation for repelling molluscs, preferably gastropods, most preferably slugs and/or snails, is described. In some examples, the treatment formulation includes a combination of metaldehyde, and/or saponin and/or a film coating composition.

In one embodiment, treated seed comprising saponin and metaldehyde is prepared by first coating a batch of seed with a liquid saponin product. The saponin product wets the seed surface. After liquid saponin composition is applied to the seed, metaldehyde powder is applied to the seed. The metaldehyde powder adheres to the liquid composition on the seed. In one embodiment, the wetted seed is applied with the maximum amount of metaldehyde powder that will adhere. Excess metaldehyde powder not adhered may be evacuated via a dust extraction apparatus (described below). The maximum amount of metaldehyde that can be adhered to a seed depends on the particular surface area:weight ratio of the seed. In a preferred embodiment, metaldehyde powder is added such that the amount of metaldehyde is between 3 grams per kilogram of seed and 40 grams per kilogram of seed. This coating process may take place in a rotating or vibrating drum of a seed coating apparatus.

After metaldehyde is added, the seed is at least partially dried in the drum (approx. 15 seconds) before a film coating is added.

The film coating binds the active ingredients to the seed, reducing loss of material during storage and handling of the seed. The film coating may also advantageously improve the seed flow through the manufacturing apparatus and/or in any seed application apparatus. The coating may reduce adhesion between seeds and/or between the seeds and the apparatus.

In addition, the film coating may impart a colour to the seed (such as blue or purple, thereby reducing the chance of being targeted by birds) and improve seed flowability. The colour may also be useful in providing a visual indication to users of the type of seed being used, or the fact that the seed has been treated.

Whilst any agriculturally acceptable film coating composition would be suitable for the treated seed of the present invention, preferred coatings include a water based polymer coating composition. For example, the products DISCO Blue L-552 and DISCO Purple L-512 (both from Incotec) are especially preferred example coating compositions. Other suitable commercially available film coatings include film coatings such as those produced under the Peridiam™ (Bayer) trade name and FLO RITE™ (BASF) trade name.

In a further embodiment, a liquid seed treatment formulation was prepared comprising saponin, metaldehyde and agriculturally acceptable film coating composition. Water was added as required. A clothianidin-containing formulation (Poncho, Bayer) and a plant growth stimulant formulation comprising humic acid/fulvic acid (GeniusCoat L439, Incotec) were also added to the formulation. Where powdered metaldehyde is used, the formulation may benefit from suspending agents such as glycerol and/or fatty alcohol ethoxylate to maintain a satisfactory dispersion of metaldehyde. The formulation was agitated, for example in an agitator vessel or chamber, moved via pumps and sprayed onto seed in an operating rotary drum coating apparatus.

In a further embodiment, a liquid seed treatment formulation was prepared comprising saponin and metaldehyde. Water was added as required. A clothianidin-containing formulation (Poncho, Bayer) and a plant growth stimulant formulation comprising humic acid/fulvic acid (GeniusCoat L439, Incotec) were also added. Where powdered metaldehyde is used, the formulation may require the addition of suspending agents such as glycerol and/or fatty alcohol ethoxylate to maintain a satisfactory dispersion of metaldehyde. The formulation was agitated, moved via pumps and sprayed onto seed in an operating rotary drum coating apparatus. The agriculturally acceptable film coating polymer was subsequently applied to the seed in the drum.

In a further embodiment, a liquid seed treatment formulation was prepared comprising an 80% saponin composition and an agriculturally acceptable film coating polymer. The formulation was moved via pumps and sprayed onto seed in an operating rotary drum coating apparatus.

In a further embodiment, a liquid seed treatment formulation was prepared comprising an 80% saponin composition. The formulation was moved via pumps and sprayed onto seed in an operating rotary drum coating apparatus. The agriculturally acceptable film coating polymer was subsequently applied to the seed.

The formulation may be applied to any seed, but preferred seeds include but are not limited to: seeds for pasture crops, pasture herb crops, cereal crops, brassica, corn, rice, sorghum and pulses. Pasture herb crops include but are not limited to: chicory, plantain, yarrow, phacelia, alfalfa, dill, dandelion, caraway, fodder beet, burnet, poppy, parsley, fennel, sorrel, minutina. Pasture crops include but are not limited to: grasses such as grasses and legume species/pulse crops include clover, Lucerne, peas and beans. Cereal crops include but are not limited to: corn, maize, barley, tricale, wheat and oats.

Additional components may also be added to the seed or seed formulations, including insecticides (e.g. clothianidin-containing formulations such as Poncho™, Bayer Crop Science), plant growth stimulants (e.g. humic acid and fulvic acid blends), fungicides such as triticonazole and prochloraz copper complex suspension (Kinto Duo™, BASF) and fluxapyroxad suspension (Systiva™, BASF).

### Apparatus

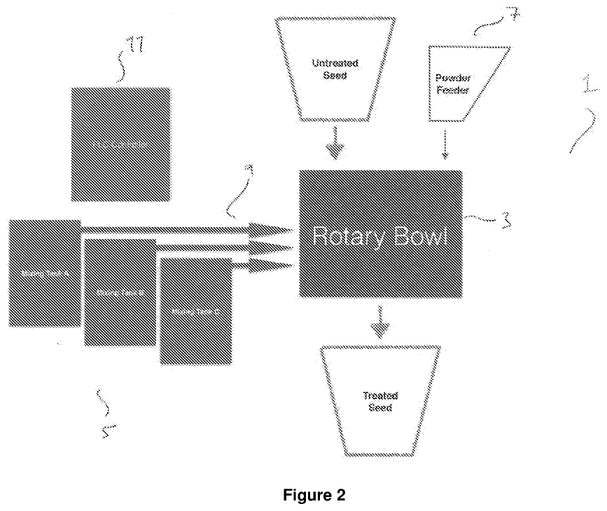

With additional reference to FIG. 2, an apparatus 1 for coating the seed comprises a seed coating apparatus (an example of which is the Cimbria Centricoater™ CC150) comprising a rotary drum 3 in communication with a plurality of agitating/mixing tanks 5 for liquid components of the composition, and a powder feeder 7 for powder components. Lines 9 from each of the mixing tanks 5 to the drum 3 comprise peristaltic pumps (which may include variable and cleanable flow regulators) and means for inline mixing.

In this example, powder is supplied from the powder feeder 7 to the rotary drum 3 via gravity, and powder doses are measured volumetrically or gravimetrically. Seed may be supplied to the drum 3 via a belt or conveyer feeder from a bulk supply of untreated seed as could be stored in a seed hopper or the like. The rotary drum 3 comprises one or more mixer formations configured to move the seed and coating components within the drum to mix the seed and coating components. In one example, the rotary drum 3 may comprises a fixed outer wall and a rotating base and upstanding mixer blade.

The addition of seed, solid components and liquid components to the drum, or to any other type of desire mixing vessel, is controllable by a programmable logic controller (PLC) 11. The PLC 11 can control the amount of each component that is supplied, the rate at which each component is supplied, and the timing of the supply of each component. The PLC 11 may be operative according to predetermined algorithms for producing one or more seed coatings and applying the coatings to one or more seeds. The PLC 11 may include one or more user inputs configured to allow the user to specify parameters of the manufacturing process. These parameters may include any one or more of: type of seed; type of coating, composition of coating (i.e. the amount, or relative proportion of each component of the composition), speed of manufacture, volume or weight of seed produced, start time, end time.

Lines 9 may be of any suitable type to form a fluid connection between the various components of the apparatus 1. In one example, food grade stainless steel tubes may be used, with an internal surface and joints configured so as to minimise any trapping of seed or other coating components in the lines 9.

A dust extractor (not shown) is also preferably included, having an intake located adjacent or inside the rotary drum. The extractor outlet may be to the external environment, or to a dust collector. The extractor is configured to be activated, for example by the PLC 11, when the apparatus 1 is activated, or at particular intervals during the coating process. In a preferred embodiment, the dust extraction apparatus is activated via the PLC 11 after seed is added to the drum 3 in order to extract the dust from the seeds and deactivated prior to addition of powder components. Some seeds generate more dust than others—the dust extractor can be controlled to provide dust extraction appropriate to the particular type of seed being coated. This may be an automatic selection by the PLC 11. The dust extractor may be configured according to a dust pre-extraction step in which the dust is extracted after delivery of seed to the drum 3, but prior to delivery of any liquid component of the seed coating.

The volume of the drum 3 in the example below is industry-rated for 150 kg wheat seed. Best results are achieved where the volume of seed is such that there is sufficient space between individual seeds to allow both the wetting of the seed, the adhesion of metaldehyde and the subsequent adhesion of film coating. For a 150 kg industry rated drum used in the example below, it has been found that optimum coverage of all components can be achieved with batches of 30 to 80 kg of seed. The apparatus 1, and PLC 11, are configured to achieve a consistent coating of the seeds in each batch.

### Example 1

The following is an example of a treated seed of the present disclosure prepared by the rotary drum coating machine described above.

To a first mixing tank was added:
a clothianidin concentrate (Poncho™, Bayer Crop Science);
a growth stimulant including a mixture of fulvic and humic acids (GeniusCoat™ L439, Incotec);
saponin, 80%;
water

It will of course be appreciated that these components could be contained in separate tanks, and, for example, mixed in-line prior to application on the seed. Thus, the apparatus 1 may be configured to premix some or all of the components prior to application to the seed in the drum 3. In a further example, the premixing may take place remote from the apparatus.

To a second mixing tank was added DISCO Blue L-552™, Incotec, which is a water based polymer film coating composition.

The first and second mixing tanks were agitated throughout the treating process.

To the first powder feeder was added metaldehyde 99% TC powder.

A batch of seed (30 to 80 kg) was added to the operating rotary drum. The dust extractor was activated to extract seed dust. Contents of the first mixing tank and the first powder feeder were added to the drum (time is approx. 15 seconds), in amounts according to Table 1 below. The seed was spun for a further 15 seconds to allow the contents to sufficiently set. The film coating composition in the second mixing tank was then added to the drum (approx. 15 seconds), and the seed was subsequently spun for a further 15 seconds in the rotary drum to allow the coating to sufficiently set.

The batch was then discharged from the drum and the product coverage and dryness of the treated seed was assessed. If the treated seed was still damp, steps were taken to dry the seed.

The final treated seed was blue in colour (where DISCO L-552 was used) or purple in colour (where DISCO L-512 was used), dry and with the active ingredients sealed onto the seed by the film coating composition.

The result of the above process was a batch of seed which has been directly coated with a composition having mollusc-repellent properties, the composition having been applied as a coating, directly to the seed, prior to the seed having been sown in the field. The treated seeds are suitable for broadcast or drill application.

Exemplary amounts of each ingredient for a particular crop seed are provided in Table 1 below.

TABLE 1

| Crop seed | Ingredient | Amount | |
|---|---|---|---|
| Brassica | Poncho ™ | 12 | ml/kg seed |
| | Saponin 80% | 2.5 | ml/kg seed |
| | Metaldehyde | 25 | g/kg seed |
| | Genius L439 | 7.5 | ml/kg seed |
| | L552 | 3.5 | ml/kg seed |
| Pasture & | Poncho ™ | per ha rate | |
| Pasture Herb | | (90 ml/ha) or per | |
| | | kg rate 4.5 ml/kg seed | |
| | Saponin 80% | 2.5 | ml/kg seed |
| | Metaldehyde | 10 | g/kg seed |
| | Genius L439 | 10 | ml/kg seed |
| | L552 | 5 | ml/kg seed |
| Cereal | Poncho ™ | 6 | ml/kg seed |
| | Saponin 80% | 2.0 | ml/kg seed |
| | Metaldehyde | 4 | g/kg seed |
| | Kinto Duo | 2 | ml/kg seed |
| | Systiva | 0.75 or 1.25 | |
| | | ml/t optional | |
| | Genius L439 | 10 ml/kg seed | |
| | | optional | |
| | L552 | 5 | ml/kg seed |
| Corn and | Poncho ™ | 4-7 | ml/kg seed |
| sorghum | | | |
| | Saponin 80% | 2.5 | ml/kg seed |
| | Metaldehyde | 10 | g/kg seed |
| | Genius L439 | 5 | ml/kg seed |
| | L552 | 5 | ml/kg seed |

| | | |
|---|---|---|
| Rice | Saponin 80% | 2 to 10 ml/kg seed |
| | Metaldehyde | 10 to 25 g/kg seed |

| | | |
|---|---|---|
| Genius L439 | 5 | ml/kg seed |
| L512 | 5 | ml/kg seed |

Water: Added as required

### Example 2

The following example describes a further seed application formulation preparation and method for its application to seeds.

To a mixing tank was added, in the following sequential order, and in amounts consistent with those shown in Table 1:
1. Clothianidin formulation (e.g. Poncho™)
2. Fulvic and humic acid formulation (e.g. Incotec GeniusCoat™ L-439)
3. Water
4. Metaldehyde powder 99%
5. Saponin Concentrate (80% saponin content)
6. Water-based polymer (Disco, Incotec)

The amounts of each component were consistent with the amounts shown in Table 1. The mixture was agitated with a rotary mixer and applied via pumps to seed in an operating rotary drum coating apparatus as described above.

If clothianidin is not required, the clothianidin formulation may be replaced with a similar volume of a composition comprising water and suspending agents such as fatty alcohol ethoxylate and glycerine.

### Example 3

The formulation and method described in Example 2 was modified by preparing a first formulation using parts labelled 1-5 above, and applying this formulation to seed as described, followed by the subsequent addition of water based polymer.

### Example 4

A seed treatment formulation was prepared, including:
1. Saponin concentrate 80%, 2-10 ml per kg of seed
2. Fulvic and humic acid formulation (e.g. Incotec GeniusCoat L-439), 5-10 ml per kg of seed
3. Clothianidin formulation (e.g. Poncho®) at rates as described at Table 1
4. Water based film coating polymer (e.g. Incotec Disco L-512 Violet), 3.5-5 ml per kg of seed
5. Water, as required

The mixture was agitated with a rotary mixer and applied via pumps to seed in an operating rotary drum.

As an alternative to adding the water-based polymer to the mixing tank, the polymer was applied to the seed separately from the other components, after the other formulated ingredients have been applied to the seed.

### Trial

Rape seeds treated according to Example 1 and Table 1, above, were sown in a 4ha paddock.

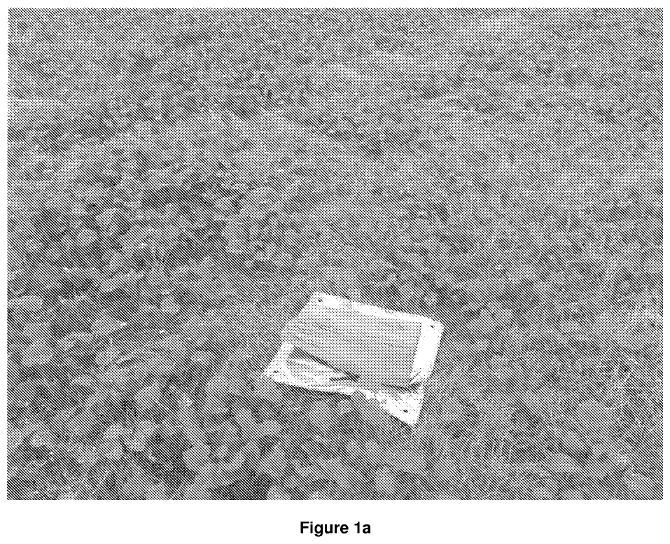

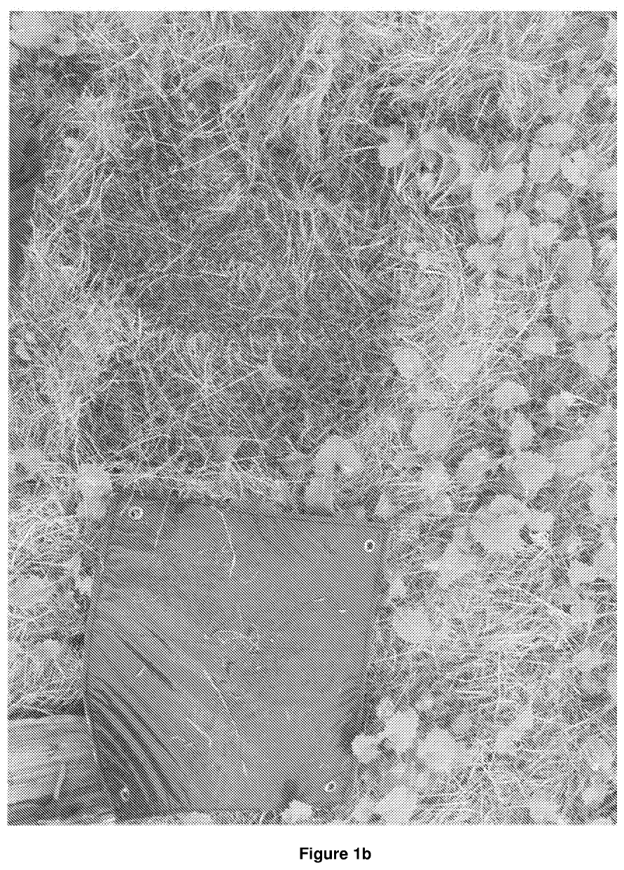

To assess the number of slugs within the paddock, four 0.25 m² mats were placed throughout the paddock after about 25 days of sowing, once the crop had established and a large number of slugs were observed. Slug numbers under each mat were measured seven days after laying the mats. During the seven days, the crop received 30-40 mm of rain under warm conditions. The crop at seven days is shown in FIGS. 1a and 1 b.

### Results at Seven Days

Mat 1
17 alive adult and juvenile slugs. Slug eggs present.
Worms, slaters and spiders also present.
Peripheral feeding damage to a small number of rape plants surrounding the mat, but the majority of plants were untouched.

Mat 2
19 alive adult and juvenile slugs. Slug eggs present.

Mat 3
32 alive adult and juvenile slugs. Slug eggs present and insect life thriving.

Mat 4
43 alive juvenile and adult slugs. Slug eggs present. Worms, slugs and spiders also present.

The slug population was measured at 111 slugs/m². There were no dead slugs present under any of the mats or in the surrounding area. All four sites had three slug species present, namely grey field, black and leaf vein.

Slug populations of 5 slugs/m² have been shown to reduce ryegrass and white clover populations by 27% and 29% respectively after 21 days (http://www.nufarm.com/Assets/1108/1/2004_Nov_SlugDamage.pdf).

Despite the relatively high slug numbers in the paddock, no substantial damage to the treated rape crop (i.e. damage that would indicate further sowing is required) was observed. The treated rape seed was able to establish successfully under relatively high slug pressure through the repellent effect of the seed treatment, with no harmful effects on the slug or other invertebrate populations.

Although this disclosure is primarily directed to a seed coating comprising a combination of metaldehyde and saponin as a mollusc repellent coating, the present disclosure also encompasses the use of an apparatus 1 for applying metaldehyde powder as part of a seed coating, and a coated seed produced by such a method. An apparatus and method in accordance with this disclosure advantageously allows the successful application of metaldehyde in powder form to relatively large batches of seed, without requiring the previously time consuming steps of producing only relatively small batches and/or having to premix the metaldehyde into a slurry.

As briefly discussed above, one or more additional components may also be added to any one or more of the above seed or seed formulations. Such additional components can include any one or more of:
insecticides, such as:
   clothianidin containing formulations such as Poncho™, Bayer Crop Science;
   cyantraniliprole containing formulations such as Lumiposa and Lumiderm;
   Chlorantraniliprole containing formulations such as Lumivia
plant growth stimulants, such as:
   humic acid and fulvic acid blends
fungicides, such as:
   triticonazole and prochloraz copper complex suspension (Kinto Duo™, BASF) and fluxapyroxad suspension (Systiva™, BASF).

### Advantages of the Disclosure

The application of the formulation of the present disclosure onto the seed may be advantageous in any one or more of the following ways (this list being in no way an exhaustive list of advantages):
Treated seed is protected from the start of its development allowing the plant to be protected proactively rather than reactively (e.g. when the crop has come under stress or withstood damage);
Use of foliar applied chemical applications may be reduced or eliminated;
Treated rice plants/seedlings growing in paddies or deep water repel aquatic or amphibious molluscs and allow the reduction in water-based pesticides or molluscicides.
Sapindus mukorossi saponin extract is particularly advantageous in achieving good mollusc and insect pest repellent properties whilst having low toxicity to humans.
The use of systemic products, such as metaldehyde, applied to seeds allows the product to be taken up by the plant during germination, prior to emergence and establishment;
A reduction in biocides, plant growth stimulant and the associated carriers when compared to broad-acre application;
Direct application onto the seed means there is a reduced negative impact on beneficial insects such as bees and earthworms;
Improved plant establishment in the presence of slugs;
Direct application onto the seed means reduced exposure of the composition to operators and handlers, and the reduction of broad-acre spraying reduces the impact on people living in the vicinity of the crops;
Use of metaldehyde powder avoids the problems (e.g. accuracy of dose, handling) associated with preparing and applying a metaldehyde slurry.

Although this invention has been described by way of example and with reference to possible embodiments thereof, it is to be understood that modifications or improvements may be made thereto without departing from the scope of the invention. The invention may also be said broadly to consist in the parts, elements and features referred to or indicated in the specification of the application, individually or collectively, in any or all combinations of two or more of said parts, elements or features. Furthermore, where reference has been made to specific components or integers of the invention having known equivalents, then such equivalents are herein incorporated as if individually set forth.

What we claim is:

1. A seed treatment comprising:
metaldehyde;
saponin; and
an agriculturally acceptable film coating composition.

2. The seed treatment of claim 1, wherein saponin is in a liquid formulation.

3. The seed treatment of claim 2, wherein the liquid formulation comprises 80% saponin content by weight.

4. The seed treatment of any one of claims 1 to 3, wherein metaldehyde is a solid.

5. The seed treatment of any one of claims 1 to 4, wherein metaldehyde is a powder.

6. The seed treatment of any one of claims 1 to 5 being a mollusc repellent seed treatment.

7. The seed treatment of any one of claims 1 to 6 wherein the concentration of saponin in the treatment is between 7 to 30%.

8. The seed treatment of any one of claims 1 to 7 wherein the concentration of saponin in the treatment is between 10 to 20%.

9. A treated plant seed comprising a seed coating comprising metaldehyde, saponin and an agriculturally acceptable film coating composition.

10. The seed of claim 9, wherein the amount of metaldehyde present in the seed coating is at least 3 g/kg of seed.

11. The seed of claim 9 or 10, wherein the amount of saponin is between 0.1 and 2.5 ml/kg of seed, preferably 2 to 2.5 ml/kg of seed.

12. The seed of any one of claims 9 to 11, wherein the plant is selected from brassica, pasture, pasture herb, cereal, corn, rice, sorghum or pulse crops.

13. The seed of any one of claims 9 to 12 being a mollusc repellent seed.

14. A method of controlling mollusc damage to plants, comprising treating the plant's seed with a combination of metaldehyde, saponin and an agriculturally acceptable film coating composition.

15. A method of controlling mollusc damage to plant seeds, comprising treating the seed with a combination of metaldehyde, saponin and an agriculturally acceptable film coating composition.

16. The method of claim 14 or 15, wherein the mollusc is a gastropod.

17. The method of any one of claims 14 to 16, wherein the mollusc is a slug.

18. The method of any one of claims 14 to 17, wherein the plant is selected from brassica, pasture, pasture herb, cereal, corn or pulse crops.

19. A method of applying a coating to a plant seed including the steps of:
applying saponin to the seed
applying metaldehyde to the seed
applying an agriculturally acceptable film coating composition to the seed.

20. The method of claim 19, wherein the saponin is in a liquid formulation.

21. The method of claim 19 or 20, wherein metaldehyde is applied as a powder.

22. The method of claim 21, wherein metaldehyde is applied in an amount of at least 3 g/kg of seed.

23. The method of any one of claims 19 to 22, wherein the plant is selected from brassica, pasture, pasture herb, cereal, corn, rice, sorghum or pulse crops.

24. A method of applying a coating to a plant seed including the steps of:
wetting the seed;
applying metaldehyde powder to the seed;
applying an agriculturally acceptable film coating composition to the seed.

25. The method of claim 24, wherein metaldehyde powder is applied in an amount of at least 3 g/kg of seed.

26. The method of claim 24 or 25, wherein the plant is selected from brassica, pasture, pasture herb, cereal, corn or pulse crops.

27. The method of any one of claims 14 to 26 wherein the ratio of the volume or mass of the seed being coated in a given batch to the volume or load rating of a mixing drum in which the seed is coated, is controlled or varied.

28. An apparatus for coating a plant seed of claims 9 to 13.

29. The apparatus of claim 28 comprising:
a rotatable drum in fluid communication with a first tank configured to contain a liquid composition and a second tank configured to contain an agriculturally acceptable film coating composition,
the drum being configured to receive and mix the seed, the liquid composition and the coating composition.

30. The apparatus of claim 28 or 29, further including a powder feeder configured to feed metaldehyde powder to the drum.

31. A seed treatment comprising:
metaldehyde in powder form; and
an agriculturally acceptable film coating composition.

32. A treated plant seed comprising a seed coating comprising metaldehyde in powder form and an agriculturally acceptable film coating composition.

33. A method of applying a coating to a plant seed including the steps of:
applying metaldehyde in powder form to the seed applying an agriculturally acceptable film coating composition to the seed.

34. An apparatus for coating a plant seed comprising:
a rotatable drum in fluid communication with a first tank configured to contain an agriculturally acceptable film coating composition,
a powder feeder configured to feed metaldehyde powder to the drum.
the drum being configured to receive and mix the seed, the metaldehyde powder and the coating composition to coat the seed.

35. A method of applying a coating to a plant seed comprising applying to the seed a liquid composition comprising saponin and an agriculturally acceptable film coating composition.

36. A treated plant seed comprising a coating comprising saponin and an agriculturally acceptable film coating composition.
